(19) United States
(12) Patent Application Publication
(10) Pub. No.: US 2026/0152097 A1
(43) Pub. Date: Jun. 4, 2026

(54) ULTRA-THIN CALF SUPPORT ASSEMBLY

(71) Applicant: Adient (Chongqing) Automotive Components Co., Ltd., Chongqing (CN)

(72) Inventors: Zhangneng SHI, Chongqing (CN); Ming ZHANG, Chongqing (CN); Zhiyong CHEN, Chongqing (CN); Yi XIN, Chongqing (CN)

(21) Appl. No.: 19/405,912

(22) Filed: Dec. 2, 2025

(30) Foreign Application Priority Data
Dec. 3, 2024 (CN) 202411759791.6

(51) Int. Cl. B60N 2/02; B60N 2/90

(52) U.S. Cl. CPC B60N 2/02; B60N 2/995; B60N 2002/0216

(57) ABSTRACT

An ultra-thin calf support assembly may have a base and a leg support bracket rotatably mounted on the base. A first extension plate may be slidably mounted on the leg support bracket. A link assembly may be provided between the first extension plate and the leg support bracket. The movement of the link assembly may be able to pull the first extension plate to slide relative to the leg support bracket. A transmission assembly may have a driving crossbar and linkage plates. One end of the linkage plate may be hinged to an end portion of the driving crossbar, and the other end thereof may be hinged to the base. A middle portion of the driving crossbar may be associated with the link assembly. When the leg support bracket rotates forward relative to the base, the transmission assembly is able to force the link assembly to move.

### Technical Field

The pres ent device relates to the technical field of leg supports for vehicle seats, and specifically to an ultra-thin calf support assembly.

### Background

Leg supports are typically folded and mounted at the bottom of vehicle seats. They are unfolded manually or electrically, and can be configured to support passengers’ calves, thereby ensuring the passengers’ riding comfort.

In the prior art, a link structure is generally used to increase the extension length of the leg support, thereby ensuring a good driving experience for passengers with various body heights. However, in the case that the link structure is folded, the overall thickness of the leg support is much thicker than that of a leg support without an extension mechanism.

In view of the above problem, the applicant has proposed an ultra-thin leg support. For details, please refer to the Chinese invention patent publication No. CN118322968A, in which an extension plate is mounted in a sliding manner to ensure that the entire leg support is made thinner when folded. In addition, through an eccentrically arranged guide block, the extension plate can slide synchronously along the first slide rail when the base plate of the leg support rotates.

Since the guide block is eccentrically arranged at the front end of the base, when the leg support is folded, its overall thickness includes not only the thickness of the leg support itself but also the thickness of the guide block itself, so there is still a need to optimize the structural compactness.

### Summary

In view of this, the present device provides an ultra-thin calf support assembly, which is intended to further reduce the overall thickness of the folded leg support.

To achieve the above objective, the technical solution is as follows:

An ultra-thin calf support assembly, comprising a base fixedly disposed at a front end of a bottom portion of a vehicle seat, and a leg support bracket rotatably mounted on the base, wherein a first extension plate is slidably mounted on the leg support bracket, and the first extension plate is configured to support an occupant's calf, characterized in that: a link assembly is provided between the first extension plate and the leg support bracket, and the movement of the link assembly is able to pull the first extension plate to slide relative to the leg support bracket; the base is provided with a transmission assembly, and the transmission assembly comprises a driving crossbar and linkage plates located at two ends of the driving crossbar, one end of the linkage plate is hinged to an end portion of the driving crossbar, and the other end thereof is hinged to the base, a middle portion of the driving crossbar is associated with the link assembly, and when the leg support bracket rotates forward relative to the base, the transmission assembly is able to force the link assembly to move.

With the above structure, through the arranged driving crossbar and link assembly, when the leg support bracket rotates relative to the base, the first extension plate can slide forward synchronously, thereby ensuring that the leg support rotates while also extending synchronously. The driving crossbar, originally mounted to slide along a guide block, has been replaced with a rotational mounting using the linkage plate. When the leg support is folded, the driving crossbar and linkage plate can be integrated into the base, further reducing the overall size of the leg support.

Preferably, the link assembly comprises a first link, a second link, and a third link, which are hinged in sequence, an end of the first link away from the second link is hinged to the calf support bracket, a middle portion of the second link is hinged to the driving crossbar, and an end of the third link away from the second link is hinged to the first extension plate. With the above structure, when the leg support bracket rotates forward relative to the base, the distance between the leg support bracket and the driving crossbar increases. Through the action of the links, the first extension plate can be unfolded forward relative to the leg support bracket, thereby causing the leg support to rotate while simultaneously unfolding forward.

Preferably, a fourth link is further provided between the first link and the third link, two ends of the fourth link are hinged to the first link and the third link, respectively, and the fourth link is arranged in parallel with the second link. With the above structure, through the use of a parallelogram structure, the link assembly can be unfolded and folded more stably.

Preferably, the base has two sets of mounting upright plates, the driving crossbar is horizontally placed at front ends of the two sets of mounting upright plates, two ends of the driving crossbar are provided with lugs bent to one side, one end of the linkage plate is hinged to the lug, and the other end thereof is hinged to the front end of the mounting upright plate; and when the leg support is in a folded state, the driving crossbar and the linkage plate are able be folded into a space enclosed by the two sets of mounting upright plates. With the above structure, the design of the lugs and mounting upright plates can facilitate the installation of the linkage plate, enables the driving crossbar and linkage plate to be folded within the space enclosed by the mounting upright plates, and can ensure a smaller overall thickness when the leg support is folded.

Preferably, the leg support bracket is provided with first slide rails on two sides, the first extension plate is slidably mounted on the first slide rails, the first extension plate is provided with second slide rails on two sides, and a second extension plate is slidably arranged on the second slide rails. With the above structure, the two-stage extension of the leg support can be realized while also making the overall thickness of the leg support smaller.

Preferably, a bottom portion of the first extension plate is provided with a telescopic driving mechanism, and the telescopic driving mechanism is configured to drive the second extension plate to slide along the second slide rails. With the above structure, the two-stage extension of the leg support can be electrically controlled.

Preferably, a rotary driving mechanism is provided between the base and the calf support bracket, and the rotary driving mechanism is configured to drive the calf support bracket to rotate relative to the base. With the above structure, the rotation of the leg support can be electrically controlled.

Preferably, the rotary driving mechanism comprises a driving electric motor, a lead screw connected to an output end of the driving electric motor, and a driving block threaded onto the lead screw, the driving electric motor is hinged to the calf support bracket, and the driving block is hinged to one end of the base away from the calf support bracket. With the above structure, the rotation of the leg support can be realized by moving the driving block on the lead screw.

Preferably, the calf support bracket is hinged to the base via a first support shaft, and the linkage plate is hinged to the base via a second support shaft, wherein the second support shaft is eccentrically arranged relative to the first support shaft. With the above structure, it can be ensured that the driving crossbar can rotate synchronously while the leg support bracket rotates, and that the link assembly can be forced to extend and retract while the driving crossbar rotates, thereby realizing synchronous extension of the first extension plate.

Compared with the prior art, the device has the following beneficial effects:

With the ultra-thin calf support assembly provided by the device, through the arranged driving crossbar and link assembly, when the leg support bracket rotates relative to the base, the first extension plate can slide forward synchronously, thereby ensuring that the leg support rotates while also extending synchronously. The driving crossbar, originally mounted to slide along a guide block, has been replaced with a rotational mounting using the linkage plate. When the leg support is folded, the driving crossbar and linkage plate can be integrated into the base, without additionally occupying the width and thickness dimensions of the push block, which is helpful for improving the compactness of the leg support.

### Brief Description of the Drawings

FIG. 1 is a schematic structural view of a leg support assembly when it is unfolded

FIG. 2 is a schematic structural view of the leg support assembly when it is folded;

FIG. 3 is a schematic structural view of a link assembly 6 in an unfolded state;

FIG. 4 is a schematic structural view showing the assembly of a second extension plate 9;

FIG. 5 is a structural schematic view showing the positional relationship between a first support shaft 12 and a second support shaft 13;

FIG. 6 is a structural schematic view of a rotary driving mechanism 11;

FIG. 7 is a schematic structural view of a driving crossbar 5.

### Detailed Description

### The device will be further described below with reference to the embodiments and drawings

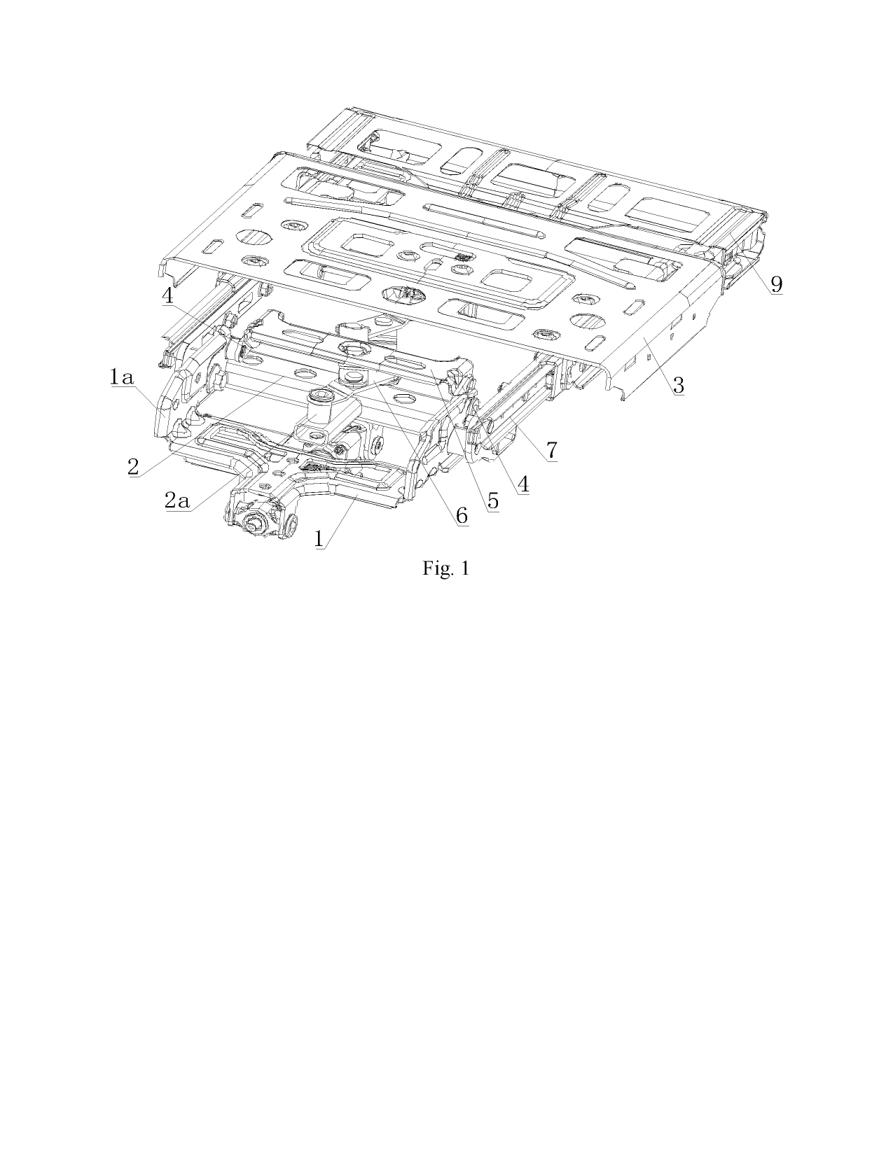

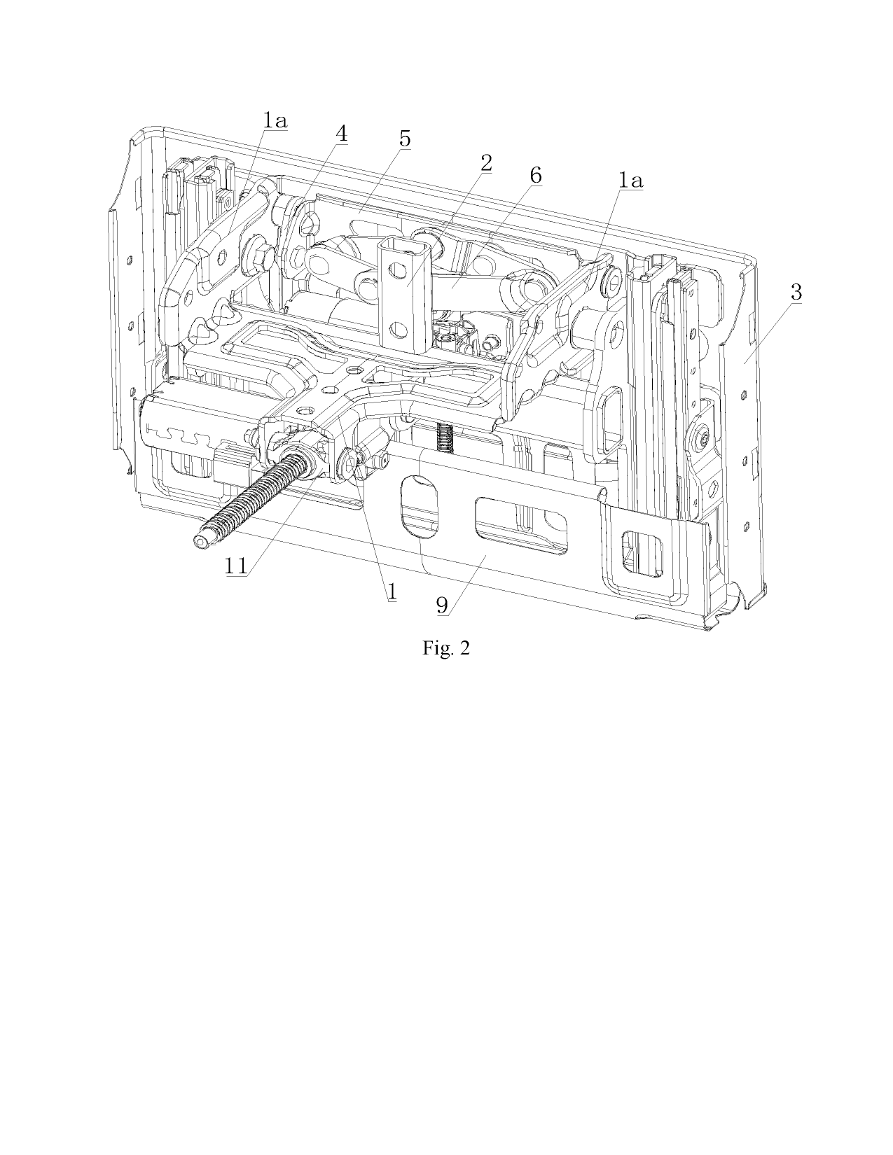

As shown in FIGS. 1 and 2, an ultra-thin calf support assembly comprises a base 1 fixedly mounted at the front end of the bottom portion of a vehicle seat, and a leg support bracket 2 rotatably mounted on the base 1. A first extension plate 3 is slidably mounted on the leg support bracket 2, and the first extension plate 3 is configured to support an occupant's calf. A link assembly 6 is mounted between the first extension plate 3 and the leg support bracket 2, and the movement of the link assembly 6 can pull the first extension plate 3 to slide relative to the leg support bracket 2. The base 1 is further provided with a transmission assembly. The transmission assembly comprises a driving crossbar 5 and linkage plates 4 located at two ends of the driving crossbar 5. One end of the linkage plate 4 is hinged to an end portion of the driving crossbar 5, and the other end thereof is hinged to the base 1. A middle portion of the driving crossbar 5 is associated with the link assembly 6. When the leg support bracket 2 rotates forward relative to the base 1, the transmission assembly is able to force the link assembly 6 to move.

Through the arranged transmission assembly, and with the middle portion of the driving crossbar 5 associated with the link assembly 6, when the leg support bracket 2 rotates forward relative to the base 1, the transmission assembly can force the link assembly 6 to move, thereby enabling the first extension plate 3 to extend forward synchronously. The driving crossbar 5 is rotatably mounted via the linkage plate 4. Compared with a sliding installation via an eccentrically arranged guide block, when the leg support is folded, the linkage plate 4 can rotate and be placed inside the base 1, further reducing the overall thickness of the folded leg support.

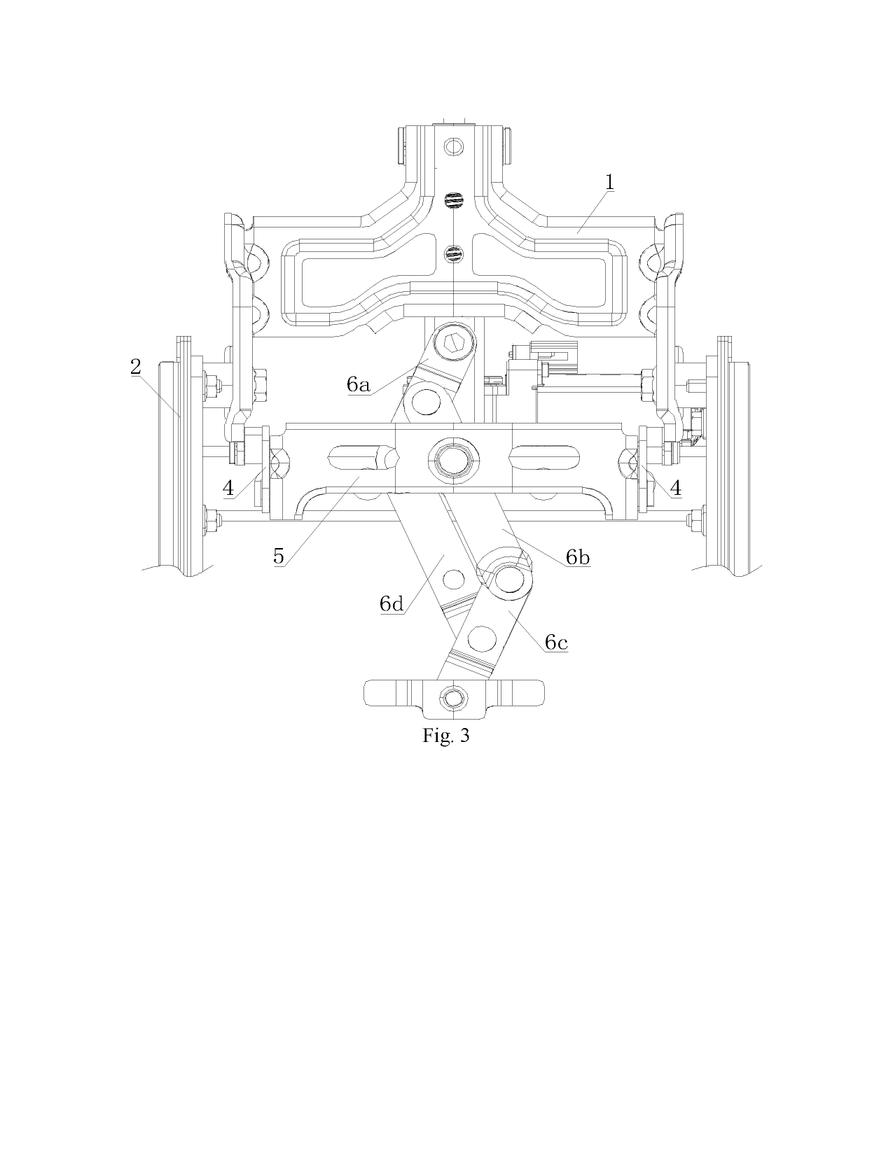

As shown in FIG. 3, the link assembly 6 comprises a first link 6a, a second link 6b, and a third link 6c, which are hinged in sequence. In this embodiment, the leg support bracket 2 extends a mounting post 2a toward the side where the first extension plate 3 is located. The end of the first link 6a away from the second link 6b is hinged to the mounting post 2a. The middle portion of the second link 6b is hinged to the middle position of the driving crossbar 5. The end of the third link 6c away from the second link 6b is hinged to the first extension plate 3. With such a design, when the leg support bracket 2 rotates forward relative to the base 1, the mounting post 2a can move away from the driving crossbar 5. Throughout the process, the link assembly 6 is in a gradually unfolded state, thereby enabling the first extension plate 3 to slide forward.

In this embodiment, a fourth link 6d is further mounted between the first link 6a and the third link 6c. Two ends of the fourth link 6d are hinged to the first link 6a and the third link 6c, respectively, and the fourth link 6d is arranged in parallel with the second link 6b. With such a design, through the use of a parallelogram structure, the link assembly 6 is folded and unfolded more stably.

As shown in FIG. 5, the leg support bracket 2 is hinged to the base 1 via a first support shaft 12, and the linkage plate 4 is hinged to the base 1 via a second support shaft 13. The second support shaft 13 is eccentrically arranged relative to the first support shaft 12, and the second support shaft 13 is close to the front end of the vehicle seat. With such a design, the leg support bracket 12 can synchronously drive the driving crossbar 5 to rotate while rotating. When the driving crossbar 5 rotates, the distance between the driving crossbar and the mounting post 2a changes, and then the link assembly 6 moves to realize synchronous sliding of the first extension plate 3.

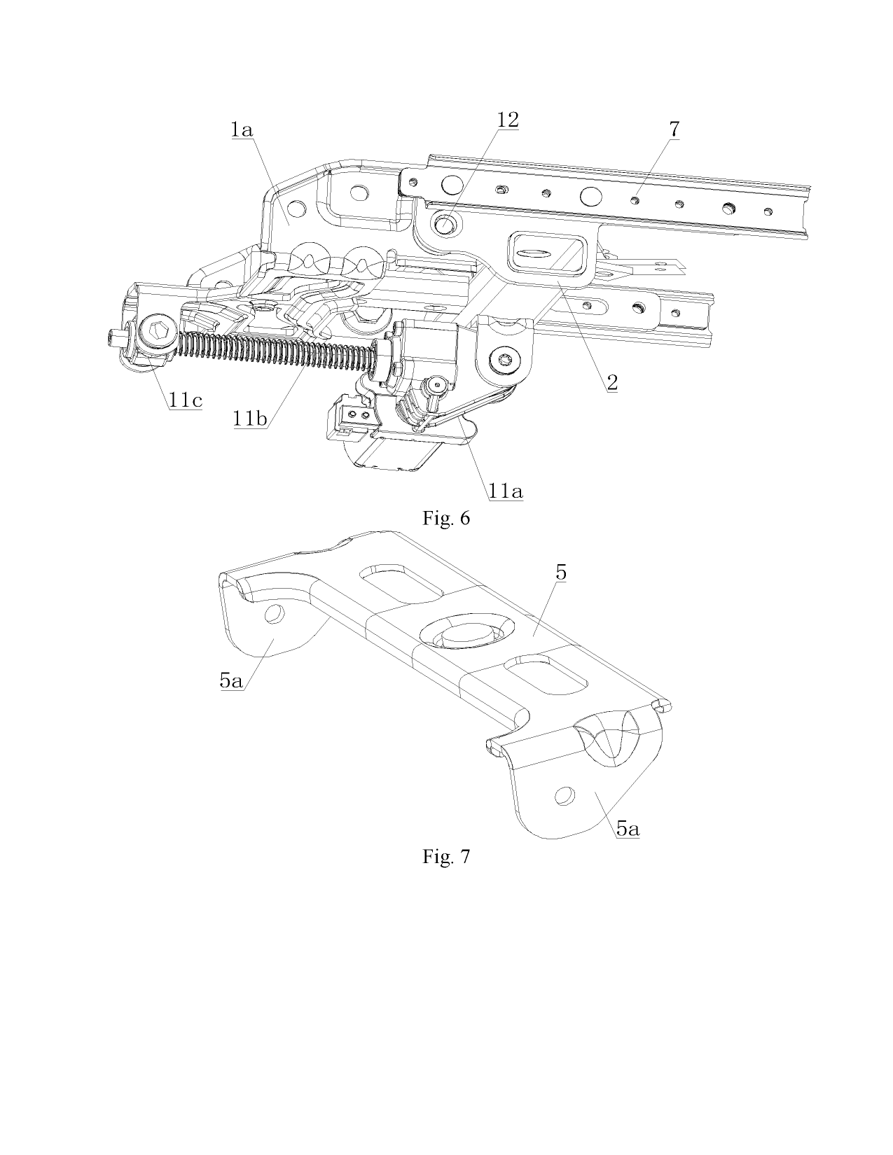

Further, as shown in FIGS. 5 and 7, mounting upright plates 1a are formed at two ends of the base 1. The driving crossbar 5 is placed horizontally at the front ends of the two sets of mounting upright plates 1a, and lugs 5a bending toward the base 1 are formed at two ends of the driving crossbar 5. One end of the linkage plate 4 is hinged to the lug 5a, and the other end thereof is hinged to the front end of the mounting upright plate 1a. When the leg support is in the folded state, the driving crossbar 5 and the linkage plate 4 can be folded into the space enclosed by the two sets of mounting upright plates 1a, thus further ensuring that the overall thickness of the leg support is lower when folded.

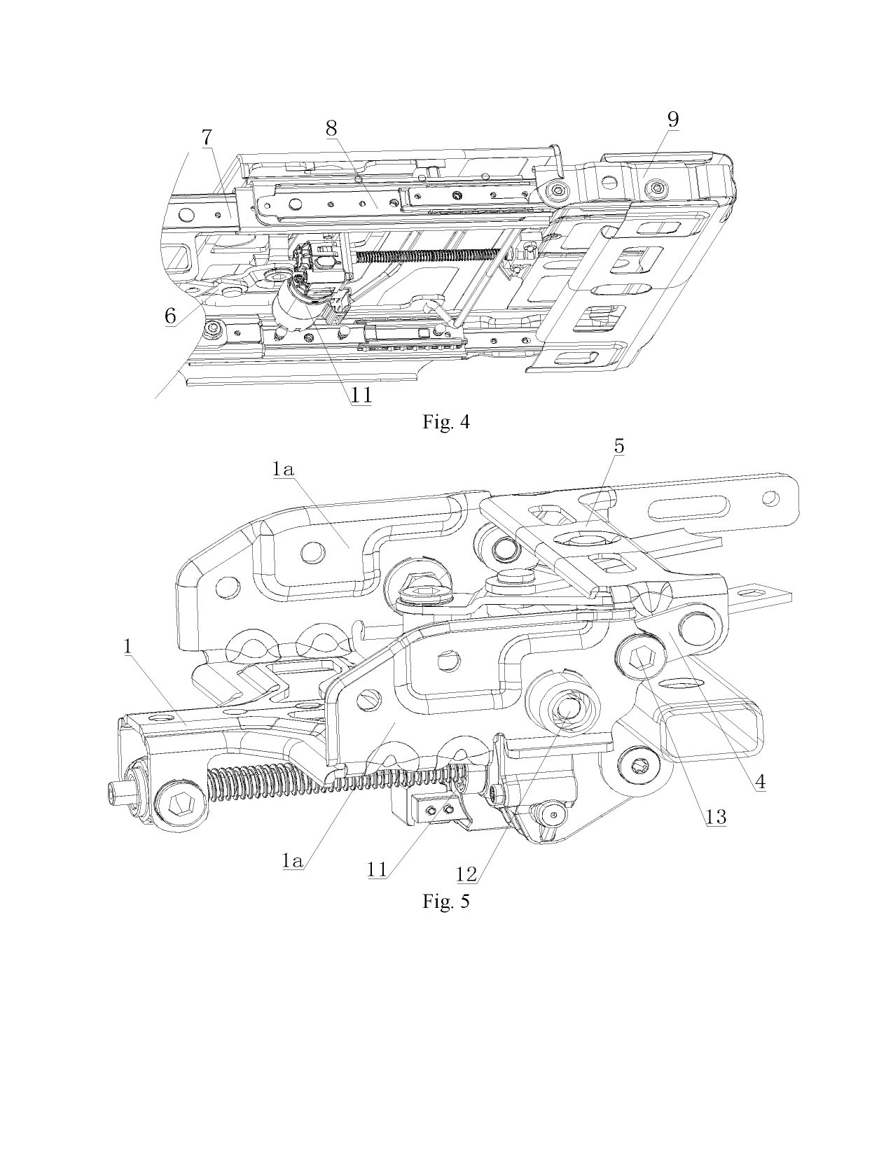

As shown in FIG. 4, first slide rails 7 are fixedly mounted on both the left and right sides of the leg support bracket 2, and a first extension plate 3 is slidably mounted on the first slide rails 7. Second slide rails 8 are fixedly mounted on both sides of the first extension plate 3, and a second extension plate 9 is slidably mounted on the second slide rails 8. With such a design, the two-stage extension of the leg support is realized, thereby adapting to the needs of occupants with a wider range of heights for leg support.

As shown in FIG. 4, a telescopic driving mechanism 10 is fixedly mounted at the bottom portion of the first extension plate 3. The telescopic driving mechanism 10 is configured to drive the second extension plate 9 to slide along the second slide rails 8. In this embodiment, the telescopic driving mechanism 10 is a lead screw motor. The middle portion of the second extension plate 9 is threaded onto the lead screw, so as to realize the electric control of the extension and retraction of the second extension plate 9.

As shown in FIG. 6, in this embodiment, a rotary driving mechanism 11 is mounted between the base 1 and the leg support bracket 2. The rotary driving mechanism 11 is configured to drive the leg support bracket 2 to rotate relative to the base 1, thereby electrically controlling the flipping of the leg support.

Specifically, the rotary driving mechanism 11 comprises a driving electric motor 11a, a lead screw 11b fixedly mounted on the output end of the driving electric motor 11a, and a driving block 11c threaded onto the lead screw 11b. The driving electric motor 11a is hinged to the leg support bracket 2, and the driving block 11c is hinged to the end of the base 1 away from the leg support bracket 2. When the driving electric motor 11a operates, under the transmission action of the lead screw 11b and the driving block 11c, the driving electric motor 11a can move closer to or further away from the driving block 11c, thereby realizing the rotation of the leg support bracket 2.

Finally, it should be noted that the above descriptions are only preferred embodiments. Those of ordinary skill in the art can make various similar modifications without departing from the spirit and scope. Such modifications are all encompassed within the scope of protection.

What is claimed is:

1. An ultra-thin calf support assembly, comprising a base fixedly disposed at a front end of a bottom portion of a vehicle seat, and a leg support bracket rotatably mounted on the base, wherein a first extension plate is slidably mounted on the leg support bracket, and the first extension plate is configured to support an occupant's calf, wherein: a link assembly is provided between the first extension plate and the leg support bracket, and the movement of the link assembly is able to pull the first extension plate to slide relative to the leg support bracket;
the base is provided with a transmission assembly, the transmission assembly comprises a driving crossbar and linkage plates located at two ends of the driving crossbar, one end of the linkage plate is hinged to an end portion of the driving crossbar, and the other end thereof is hinged to the base, a middle portion of the driving crossbar is associated with the link assembly, and when the leg support bracket rotates forward relative to the base, the transmission assembly is able to force the link assembly to move.

2. The ultra-thin calf support assembly as claimed in claim 1, wherein: the link assembly comprises a first link, a second link, and a third link, which are hinged in sequence, an end of the first link away from the second link is hinged to the calf support bracket, a middle portion of the second link is hinged to the driving crossbar, and an end of the third link away from the second link is hinged to the first extension plate.

3. The ultra-thin calf support assembly as claimed in claim 2, wherein: a fourth link is further provided between the first link and the third link, two ends of the fourth link are hinged to the first link and the third link, respectively, and the fourth link is arranged in parallel with the second link.

4. The ultra-thin calf support assembly as claimed in claim 1, wherein: the base has two sets of mounting upright plates, the driving crossbar is horizontally placed at front ends of the two sets of mounting upright plates, two ends of the driving crossbar are provided with lugs bent to one side, one end of the linkage plate is hinged to the lug, and the other end thereof is hinged to the front end of the mounting upright plate;
when the leg support is in a folded state, the driving crossbar and the linkage plate are able be folded into a space enclosed by the two sets of mounting upright plates.

5. The ultra-thin calf support assembly as claimed in claim 1, wherein: the leg support bracket is provided with first slide rails on two sides, the first extension plate is slidably mounted on the first slide rails, the first extension plate is provided with second slide rails on two sides, and a second extension plate is slidably arranged on the second slide rails.

6. The ultra-thin calf support assembly as claimed in claim 5, wherein: a bottom portion of the first extension plate is provided with a telescopic driving mechanism, and the telescopic driving mechanism is configured to drive the second extension plate to slide along the second slide rails.

7. The ultra-thin calf support assembly as claimed in claim 1, wherein: a rotary driving mechanism is provided between the base and the calf support bracket, and the rotary driving mechanism is configured to drive the calf support bracket to rotate relative to the base.

8. The ultra-thin calf support assembly as claimed in claim 7, wherein: the rotary driving mechanism comprises a driving electric motor, a lead screw connected to an output end of the driving electric motor, and a driving block threaded onto the lead screw, the driving electric motor is hinged to the calf support bracket, and the driving block is hinged to one end of the base away from the calf support bracket.

9. The ultra-thin calf support assembly as claimed in claim 1, wherein: the calf support bracket is hinged to the base via a first support shaft, and the linkage plate is hinged to the base via a second support shaft, wherein the second support shaft is eccentrically arranged relative to the first support shaft.
